(19) United States
(12) Patent Application Publication
(10) Pub. No.: US 2018/0073595 A1
(43) Pub. Date: Mar. 15, 2018

(54) POWER TRAIN

(71) Applicant: HYUNDAI MOTOR COMPANY, Seoul (KR)

(72) Inventors: Jae Bum PARK, Suwon-si (KR); Yeonho KIM, Suwon-si (KR); Hee Ra LEE, Anyang-si (KR)

(73) Assignee: HYUNDAI MOTOR COMPANY, Seoul (KR)

(21) Appl. No.: 15/374,410

(22) Filed: Dec. 9, 2016

(30) Foreign Application Priority Data
Sep. 9, 2016 (KR) 10-2016-0116713

(51) Int. Cl. F16F 15/28; F02B 75/18; F02N 11/08; F02B 75/32

(52) U.S. Cl. CPC F16F 15/283; F02B 75/18; F02B 2075/1808; F02B 75/32; F02N 11/0851

(57) ABSTRACT

A power train may include: a 2-cylinder engine which includes a first piston disposed within a first cylinder, a second piston disposed within a second cylinder, and a crankshaft connected to the first and second pistons through first and second crank pins, respectively; a motor; a transmission connected to the motor; a clutch selectively connecting the motor to the crankshaft; and a weight portion. In particular, the weight portion includes: an inner rim connected to the crankshaft; an outer rim; a disk connected to the inner rim and the outer rim; and a balance weight. The balance weight is connected to the inner rim, the disk and the outer rim.

### CROSS-REFERENCE TO RELATED APPLICATION

This application claims priority to and the benefit of Korean Patent Application No. 10-2016-0116713, filed Sep. 9, 2016, the entire contents of which are incorporated herein by reference.

### FIELD

The present disclosure relates to a power train. More particularly, the present disclosure relates to a power train provided with a 2-cylinder engine and a motor.

### BACKGROUND

The statements in this section merely provide background information related to the present disclosure and may not constitute prior art.

Recently, various types of research has been undertaken to enhance fuel efficiency of a vehicle. For example, a two cylinder engine or a three cylinder engine is under development for purposes of fuel efficiency improvement.

However, two cylinder engines and three cylinder engines have a limited capability to adjust their output according to various vehicle driving conditions so that the fuel efficiency decreases.

Also, we have discovered that the two cylinder engine or the three cylinder engine induces serious vibration and that the engines' structure causes limitation to applying a vibration damping element, such as a balance shaft configured to suppress vibration.

The above information disclosed in this Background section is only for enhancement of understanding of the background of the present disclosure and therefore it may contain information that does not form the prior art that is already known to a person of ordinary skill in the art.

### SUMMARY

The present disclosure provides a power train provided with a 2-cylinder engine and a motor for reducing vibration and noise and thereby enhancing fuel efficiency.

A power train in one form of the present disclosure may include: a 2-cylinder engine which includes a first piston disposed within a first cylinder, a second piston disposed within a second cylinder, and a crankshaft connected to the first and second pistons through a first crank pin and a second crank pin, respectively; a motor; a transmission connected to the motor; a clutch configured to selectively connect the motor to the crankshaft; and a weight portion including an inner rim configured to contact the crankshaft, a disk connected to the inner rim and an outer rim of the weight portion, and a balance weight. In particular, the balance weight is connected to the inner rim, the disk and the outer rim.

The balance weight may be disposed to be symmetrical to corresponding positions to positions of the first and second crank pins.

The first crank pin and the second crank pin are aligned with an angular offset each other with respect to the crank shaft so that phases of the first crank pin and the second crank pin may be not coincident.

The balance weight may include a first balance unit and a second balance unit, forming a pair.

The weight portion may be disposed between the engine and the clutch.

The weight portion may be disposed on an opposite side of the motor.

The weight portion may be disposed between the first cylinder and the second cylinder.

A power train provided with a 2-cylinder engine and a motor according to various exemplary forms of the present disclosure may reduce vibration and noise and enhance fuel efficiency.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view illustrating a power train;

FIG. 2 is a perspective view of a weight portion applied to various exemplary forms of the present disclosure;

FIG. 3A is a schematic side view of an engine applied to a power train;

FIG. 3B is a longitudinal view of the engine in FIG. 3A; and

FIG. 4 and FIG. 5 are drawings showing a power train in various exemplary forms.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As those skilled in the art would realize, the described forms may be modified in various different ways, all without departing from the spirit or scope of the present disclosure

Parts irrelevant to the description will be omitted to clearly describe the present disclosure, and the same or similar elements will be designated by the same reference numerals throughout the specification.

In the drawings, the thickness of layers, films, panels, regions, etc., are exaggerated for clarity.

Throughout the specification and the claims, unless explicitly described to the contrary, the word “comprise” and variations such as “comprises” or “comprising”, will be understood to imply the inclusion of stated elements but not the exclusion of any other elements.

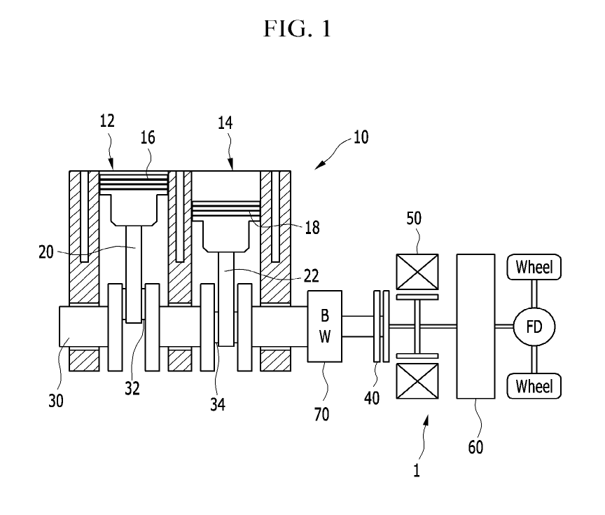

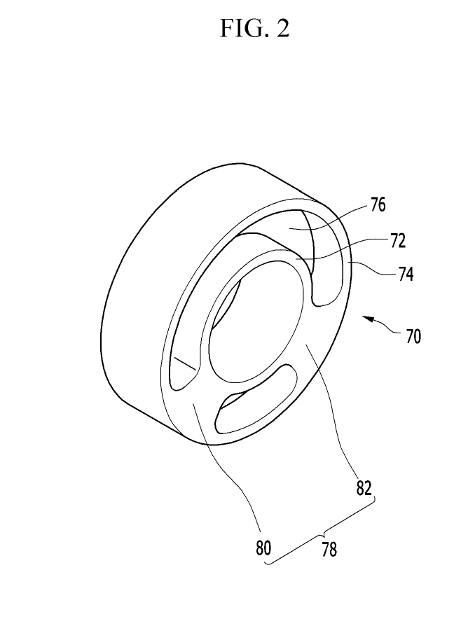

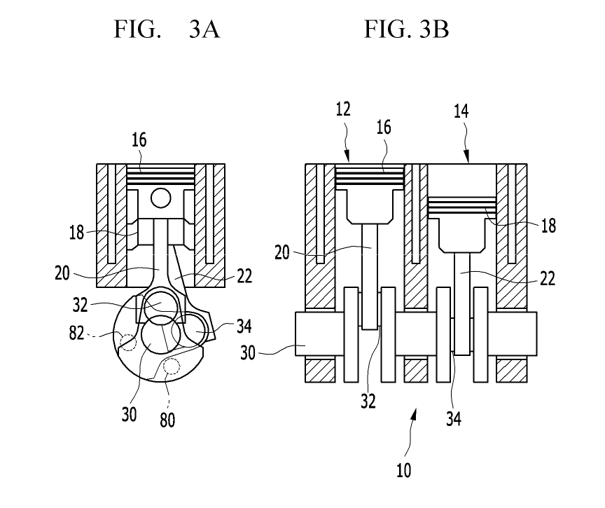

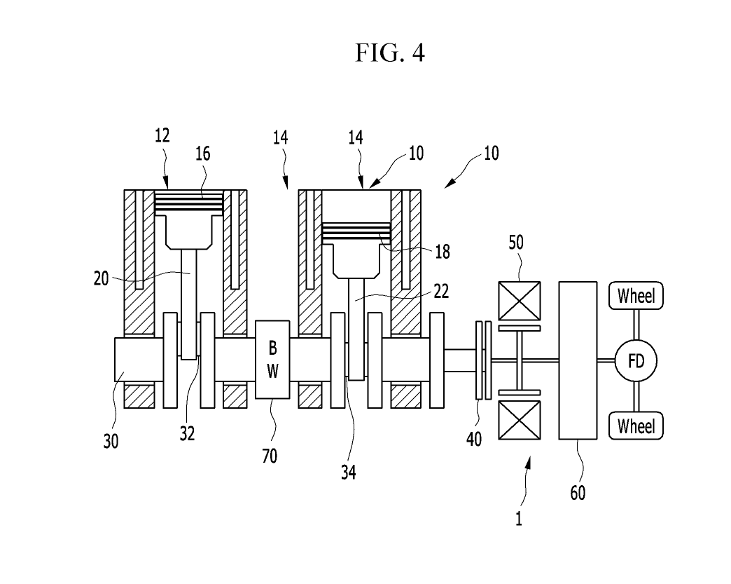

FIG. 1 is a drawing showing a power train in various exemplary forms of the present disclosure; FIG. 2 is a perspective view of a weight portion applied to various exemplary forms of the present disclosure; and FIGS. 3A and 3B are schematic views showing an engine applied to a power train in one exemplary form of the present disclosure.

Referring to FIG. 1 to FIG. 3B, a power train 1 includes: a 2-cylinder engine 10 including a first piston 16 disposed within a first cylinder 12; a second piston 18 disposed within a second cylinder 14; a crankshaft 30 connected to the first and the second pistons 16, 18 through a first crank pin 32 and a second crank pin 34, respectively; a motor 50; a transmission 60 connected to the motor 50; a clutch 40 selectively connecting the motor 50 to the crankshaft 30 and a weight portion 70.

Referring to FIG. 2, the weight portion 70 includes: an inner rim 72 contacting the crankshaft 30; a disk 76 connected to the inner rim 72 and an outer rim 74; and a balance weight 78 which is connected to the inner rim 72, the disk 76 and the outer rim 74. In another form, the balance weight 78 may be formed along a circumferential direction of the weight portion 70.

The balance weight 78 is disposed to be symmetrical to corresponding positions to the first and the second crank pin 32 and 34. The balance weight 78 may be formed as a pair.

As shown in FIG. 2 and FIGS. 3A and 3B, relative positions of the first and the second pistons 16 and 18 are not coincident and thus power stroke phase may be performed asymmetrically. And thus amplification due to overlapping of vibration from the first cylinder 12 and the second cylinder 14 may be prevented or suppressed.

As shown in FIGS. 3A and 3B, since the first crank pin 32 and the second crank pin 34 are aligned with an angular offset each other with respect to the crank shaft 30, the phases of the first crank pin 32 and the second crank pin 34 are different from each other when the engine runs. In order to compensate vibration caused by the different phases of the first and second crank pins 32, 34 while the engine runs, the balance weight 78 includes a first and a second balance weight unit 80 and 82. The first and second balance weight units 80, 82 are respectively disposed to be symmetrical to the corresponding positions of the first and the second crank pin 32 and 34.

Since the weight portion 70 includes the inner rim 72 connected to the crankshaft 30, and the disk 76 connected to the inner rim 72 and the outer rim 74, the layout of the weight portion 70 is simple so that the inner rim 72 and the crankshaft 30 is easily connected.

In particular, since the inner rim 72 is easily connected to the crankshaft 30 due to its simple shape, the weight portion 70 may be connected to the crankshaft 30 with various schemes.

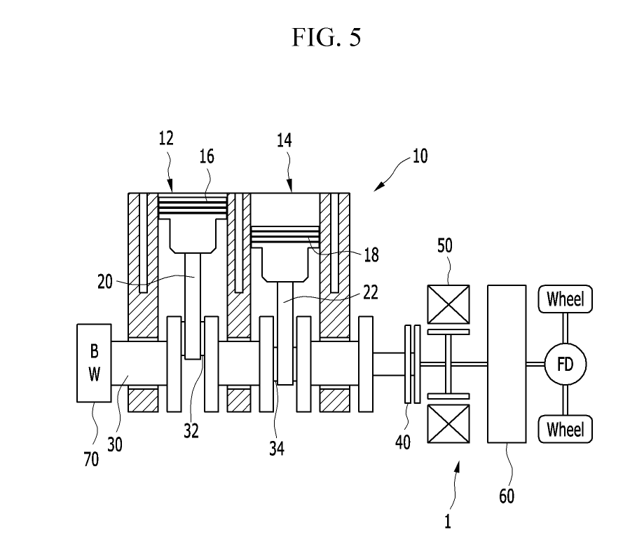

FIG. 4 and FIG. 5 are drawings showing a power train in various exemplary forms of the present disclosure.

Referring to FIG. 1, the weight portion 70 is arranged between the engine 10 and the clutch 40.

Referring to FIG. 4, the weight portion 70 is disposed between the first cylinder 12 and the second cylinder 14.

Also, Referring to FIG. 5, the weight portion 70 is disposed on the front side of the engine so that the weight portion 70 is located on the opposite side of the motor 50. The position of the weight portion 70 may vary based on the layout of the power train.

In general, the 2-cylinder engine may be compact in size and enhance fuel efficiency, but it has a limited capacity in generating maximum output and generates excessive vibration.

In order to address these problems, the present disclosure provides the power train 1 equipped with the motor 50 which is disposed between the engine 10 and the transmission 60 in order to reduce vibration and to assist output of the engine 10.

In one form, the clutch 40 may selectively connect the motor 50 to the engine 10. The motor 50 may be operated as a starter motor, operated for assisting power of the engine 10, or operated as a main power source by sopping the engine 10 if desired.

While the present disclosure has been described in connection with what is presently considered to be practical exemplary forms, it is to be understood that the present disclosure is not limited to the disclosed forms. On the contrary, it is intended to cover various modifications and equivalent arrangements included within the spirit and scope of the present disclosure.

<Description of symbols>

| | |
|---|---|
| 1: power train | 10: 2-cylinder engine |
| 12: first cylinder | 14: second cylinder |
| 16: first piston | 18: second piston |
| 20: first connecting rod | 22: second connecting rod |
| 30: crankshaft | 32: first crank pin |
| 34: second crank pin | 40: clutch |
| 50: motor | 60: transmission |
| 70: weight portion | 72: inner rim |
| 74: outer rim | 76: disk |
| 78: balance weight | 80: first balance weight unit |
| 82: second balance weight unit | |

What is claimed is:

1. A power train comprising:
a 2-cylinder engine including a first piston disposed within a first cylinder, a second piston disposed within a second cylinder, and a crankshaft connected to the first and second pistons through a first crank pin and a second crank pin, respectively;
a motor;
a transmission connected to the motor;
a clutch configured to selectively connect the motor to the crankshaft; and
a weight portion including an inner rim configured to contact the crankshaft, a disk connected to the inner rim and an outer rim of the weight portion, and a balance weight,
wherein the balance weight is connected to the inner rim, the disk and the outer rim.

2. The power train of claim 1, wherein the balance weight is disposed to be symmetrical to corresponding positions to positions of the first and the second crank pin.

3. The power train of claim 2, wherein the first crank pin and the second crank pin are aligned with an angular offset each other with respect to the crank shaft so that phases of the first crank pin and the second crank pin are not coincident.

4. The power train of claim 1, wherein the balance weight includes a first balance unit and a second balance unit, forming a pair.

5. The power train of claim 1, wherein the weight portion is disposed between the 2-cylinder engine and the clutch.

6. The power train of claim 1, wherein the weight portion is disposed on an opposite side of the motor.

7. The power train of claim 1, wherein the weight portion is disposed between the first cylinder and the second cylinder.
